(19) United States
(12) Patent Application Publication
(10) Pub. No.: US 2019/0197628 A1
(43) Pub. Date: Jun. 27, 2019

(54) Method of Providing Collateral Financed Premium for Insurance Policy and System Thereof

(71) Applicants: Andy Castro, Newport Beach, CA (US); Vi LEE, Newport Beach, CA (US); Danny H. Tran, Newport Beach, CA (US)

(72) Inventors: Andy Castro, Newport Beach, CA (US); Vi LEE, Newport Beach, CA (US); Danny H. Tran, Newport Beach, CA (US)

(21) Appl. No.: 16/231,258

(22) Filed: Dec. 21, 2018

Related U.S. Application Data
(60) Provisional application No. 62/609,321, filed on Dec. 21, 2017.

(51) Int. Cl. G06Q 40/08; G06Q 40/02

(52) U.S. Cl. CPC G06Q 40/08; G06Q 40/025

(57) ABSTRACT

A method of providing collateral financed premium for an insurance policy includes the steps of securing a premium loan from a lender for annual premiums of an insured borrower of an insurance policy, and securing a collateral loan from a third party for payment of interests of the annual premium loan, wherein the interest of the financed premium will be paid by the collateral loan when an earning income from a contract value of the insurance policy is less than the annual interest of the premium loan. In addition, in computation of the contract value and the total premium loan required, credit rate of the contract value for at least the first two years of the insurance policy is set as zero percent.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention is related to insurance, and more particularly to a method of providing collateral financed premium for insurance policy.

### Description of Related Arts

Life insurance is a common means for an individual to provide secured fund for his or her heirs after death or even provide borrowable assets during the insurance policy. However, the insurance applicant will bear a burden of paying the premiums periodically to the insurer in order to remain his or her life insurance policy in force by paying the required premiums.

A lender such as a bank may provide loan to a borrower for purchasing a real property while the real property may also bear a risk of becoming a negative equity, especially during economic depression. The value of a real property may be reduced to less than the loan amount. But if a lender can provide loan for the borrower for the premium of his or her life insurance policy, the lender will be paid back the loan amount plus agreed interest as late as after the dead of the borrower, i.e. the insured individual, as a policy's beneficiary from the death benefit of the policy. Despite this there are problems remained unsolved to such financed premium concept as follows.

The interest rates of the premium loan may rise to more than the gain of cash value of the insurance policy. In other words, when the earning of the investment (rate of return) of the premium paid by the insured is less than the interest added to the premium loan, the insurance policy fails to pay the interest of the premium loan. The lender may require a termination of the insurance policy and the insurer to pay back the premium loan. If the policy underperforms the loan balance, it can exceed the valve of the collateral, so that the insured would be forced to provide more collateral to avoid default. The qualification of the insured is difficult to be determined to both the insurer and the lender.

### SUMMARY OF THE PRESENT INVENTION

The invention is advantageous in that it provides a method of providing collateral financed premium for insurance policy, wherein low variable interest rate is provided and the insured is abler to lock the interest rate at any time.

Another advantage of the invention is to merely qualify each institution in the first year to guarantee for 20 premium loans and in maximum for 10 years so that the insured is always covered by the insurance policy.

Another advantage of the invention is to educate the arbitrage to each insurance applicant, wherein the insured is encouraged to pay interest of the premium loan of his or her insurance policy to strengthen the arbitrage by the amount of the interest rate.

Another advantage of the invention is to collect the collateral at the highest point of the premium load plus twenty to thirty percentage, depending on the age and health condition of the insured, so as to provide a security gap for even the market provides zero percent returns to the premium of the insurance policy for a predetermined period of time before the premium loan is paid back to the lender.

Another advantage of the invention is to allocate a fixed account to insure over the maximum guarantee and to provide a stress test to each insurance policy application.

Additional advantages and features of the invention will become apparent from the description which follows, and may be realized by means of the instrumentalities and combinations particular point out in the appended claims.

According to the present invention, the foregoing and other objects and advantages are attained by a method of providing collateral financed premium for insurance policy, comprising the steps of:

(A) selecting a life insurance policy, wherein an accumulated contract value of said life insurance policy covers an annual premium of the life insurance police;

(B) providing a loan agreement between a insured of said life insurance police and a lender for using a premium loan to pay said an annual premium of said life insurance policy, wherein said life insurance policy is used as a collateral of said loan agreement; and

(C) terminating said life insurance policy and said loan agreement while said accumulated contract value of said life insurance policy covers said premium load and said premium interest of said loan agreement.

In a preferred embodiment, the method of providing collateral financed premium for insurance policy, further comprises a step of I between the step (B) and step (C):

(I) borrowing from said lender according to the a net death benefit of said life insurance policy and accumulated borrow load from contract value while said premium loan paid from said lender.

In a preferred embodiment, the method of providing collateral financed premium for insurance policy, further comprises a step:

(II) avoiding a default of said life insurance policy by said lender through paying an interest of said premium loan by said insured.

In a preferred embodiment, the method of providing collateral financed premium for insurance policy, further comprises a step:

(III) paying the interest of said premium load through an additional collateral provided by said third party.

In a preferred embodiment, the method of providing collateral financed premium for insurance policy, wherein said additional collateral is a letter of credit.

In a preferred embodiment, the method of providing collateral financed premium for insurance policy, wherein said third party is introduced by an insurance carrier of said life insurance policy.

In a preferred embodiment, the method of providing collateral financed premium for insurance policy, wherein said letter of credit covers a period of interest of said premium load.

In a preferred embodiment, the method of providing collateral financed premium for insurance policy, wherein an earning income covers said interest of said premium loan, said letter of credit stopping being cashed out.

In a preferred embodiment, the method of providing collateral financed premium for insurance policy as recited in claim 1, wherein a collateral assignment is recorded on a books of an insurance carrier that issued said life insurance policy.

In a preferred embodiment, the method of providing collateral financed premium for insurance policy, wherein a credit rate for first two years of said insurance policy is set as zero percent in said loan agreement and said insurance policy.

In a preferred embodiment, the method of providing collateral financed premium for insurance policy, wherein said credit rate is set starting 7.12% from the third year of said life insurance policy.

In a preferred embodiment, the method of providing collateral financed premium for insurance policy, wherein said premium loan interest is change annually.

In accordance with another aspect of the invention, the present invention comprises a method of providing collateral financed premium for insurance policy, comprises the steps of:

(I) purchasing an insurance policy with collateral financed premium on a invested business for a valuation of said invested business by a venture capital investor;

(II) purchasing a life insurance policy with collateral financed premium on a business owner of said invested business; and

(III) setting a agreement between said venture capital investor and said business owner of said invested business regarding to pay off the spouse of the business owner through said insurance policy and pay off said venture capital investor through said life insurance policy of said business owner.

In a preferred embodiment, the method of providing collateral financed premium for insurance policy, comprises a step of:

(IV) purchasing a life insurance policy on a key person of said invested business.

In a preferred embodiment, the method of providing collateral financed premium for insurance policy, comprising a step of:

(V) setting an agreement between said venture capital investor and said key person of said invested business regarding to pay off the spouse of the business owner through said insurance policy and pay said venture capital investor through said life insurance policy of said business owner.

In a preferred embodiment, the method of providing collateral financed premium for insurance policy, wherein said insurance policy with collateral financed premium defines:

(I.1) paying an annual premium of said insurance policy until a contract value of said insurance policy covered said annual premium of said insurance policy by said venture capital investor;

(1.2) securing a load agreement between said venture capital investor and a lender through using said insurance policy as a collateral; and

(1.3) paying said an annual premium of said insurance policy through a load premium of said load agreement by said lender while said contract value of said insurance policy covered said annual premium of said insurance policy.

In a preferred embodiment, the method of providing collateral financed premium for insurance policy wherein said life insurance policy with collateral financed premium defines:

(I.1) paying an annual premium of said life insurance policy until a contract value of said insurance policy covered said annual premium of said insurance policy by said business owner;

(I.2) securing a load agreement between said business owner and a lender through using said life insurance policy as a collateral; and

(I.3) paying said an annual premium of said life insurance policy through a load premium of said load agreement by said lender while said contract value of said insurance policy covered said annual premium of said insurance policy.

In a preferred embodiment. the method of providing collateral financed premium for insurance policy, further comprises a step:

(a) avoiding a default of said life insurance policy by said lender through paying an interest of said premium loan by said insured.

In a preferred embodiment, the method of providing collateral financed premium for insurance policy, further comprises a step:

(b) paying the interest of said premium load through an additional collateral provided by said third party.

In a preferred embodiment, the method of providing collateral financed premium for insurance policy, wherein said additional collateral is a letter of credit.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a table of an exemplary insured individual of a life insurance policy with collateral financed premium according to the preferred embodiment of the present invention.

FIG. 2 is block diagram of a system according to the preferred embodiment of the present invention.

### DETAILED DESCRIPTION OF THE PREFERRED EMBODIMENT

The following description is disclosed to enable any person skilled in the art to execute and use the present invention. Exemplary embodiments are provided in the following description only as examples and modifications will be apparent to those skilled in the art. The general principles defined in the following description would be applied to other embodiments, alternatives, modifications, equivalents, and applications without departing from the spirit and scope of the present invention.

A secured loan is a type of security interest which arises when a lender and borrower agree in a security agreement that the lender, as the secured party, may take specific collateral owned by the borrower if the borrower defaults on the loan.

A lender, such a bank, and a borrower who is a life insurance applicant secure a premium loan based upon a life insurance policy of the borrower to pay the premium of the life insurance policy for the borrower, i.e. the insured of the life insurance policy. The agreement between the lender and the borrower of such premium loan could be considered as a security agreement which is a collateral assignment recorded on the books of the insurance carrier (insurer) that issued the life insurance policy. The secured party is able to obtain title to the life insurance policy based on the recordation of such collateral assignment and security agreement.

Generally, an insured party would be an entity or an individual who purchased an insurance policy by paying an insurance carrier such as an insurance company a premium. According to the exemplary embodiment of the present invention, the insurance policy is a life insurance policy which may name the insured as both the record owner and the beneficial owner. The insured is responsible for making periodic premium payments to the insurance company in order to maintain the insurance policy and thus the insured is entitled to any benefit conferred by the insurance policy.

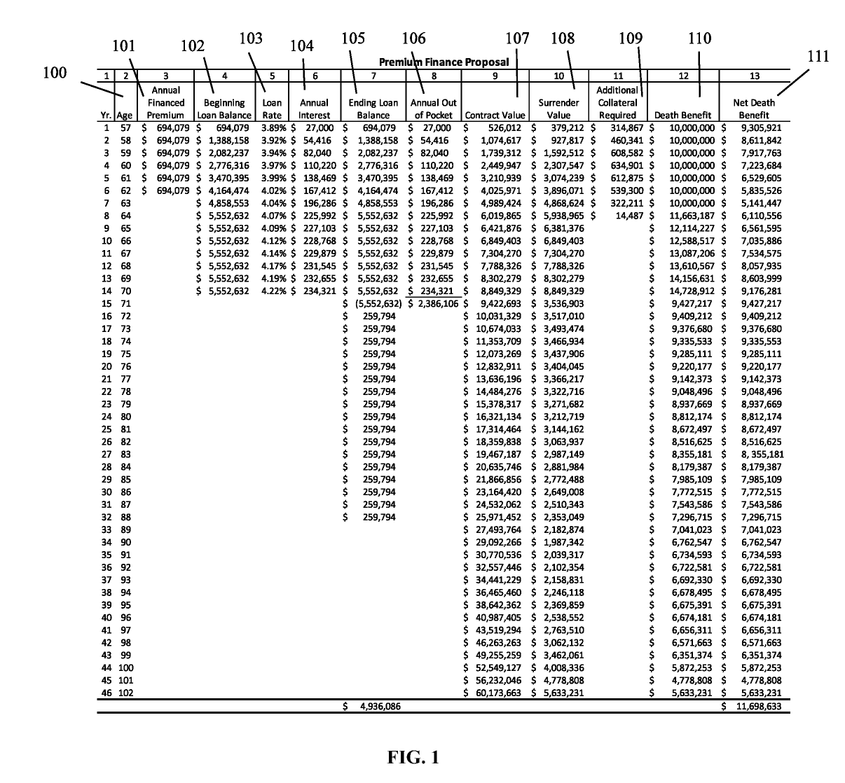

As shown in FIG. 1, as an example, an individual purchased a life insurance policy for a face amount US$10,000,000 (death benefit) at the age of fifty seven years to old. The annual premium will be US$694,079. In other words, the insured has to pay a premium of US$694,079 every year until the total contract value accumulated to an amount that is able to gain earning value per year equal to or more than the annual premium to be paid by the insured. Then, the insured may select to continue to pay the annual premium every year to accumulate the contract value or not to pay his or her annual premium and authorize the insurance carrier to use the annual earning income from the contract value to pay the annual premium.

According to the exemplary embodiment as shown in FIG. 1, the life insurance policy is embodied to have an annual crediting rate 7.12%. A lender such as a commercial bank is engaged with the insurance carrier and the insured under a security agreement to lend the insured an annual fund equal to the annual premium, for example US$694,079, and secure such loan transaction using this life insurance policy as collateral for the loan for premium payment. Accordingly, the annual premium becomes annual financed premium and the insured becomes an insured borrower to the lender under the above security agreement and, preferably, another loan agreement incorporated with the security agreement between the lender and the insured borrower.

Accordingly, the lender will pay the financed premium US$694,079 of the life insurance policy for the insured borrower annually. In order to ensure the crediting rate of interest can produce earning value to cover the annual premium, the credit rate for first two years of the insurance policy is set as zero percent (0%) in the security agreement and the insurance policy when computing the annual interest of the loan for the financed premium with a loan rate of interest. A reasonable credit rate, for example 7.12%, will be set starting from the third year of the insurance policy. As illustrated in FIG. 1, after the eight years from the insurance policy, at the age of sixty-four, eight financed premiums, a total of US$5,552,632 net loan balance is paid by the lender as eight annual financed premiums for the insured borrower. The premium loan interest may change annually, for example it increases by 0.02˜0.03% each year due to the accumulation of the loan balance. For example, the premium loan interests from year one to year fourteen of the insurance policy are 3.89%, 3.92%, 3.94%, 3.99%, 4.02%, 4.04%, 4.07%, 4.09%, 4.12%, 4.14%, 4.17%, 4.19%, and 4.22% respectively. A total of premium loan interest is US$2,386,106. Therefore, the premium loan balance plus the premium loan interest will be a sum of US$7,938,738.

According to the above exemplary embodiment, even though the credit rate is 0% for the first two years and there is no earning income and there is around a 7.12% credit rate from the third, the contract value in the eighth year will be around US$6,019,865 and it can cover the ninth premium. In other words, the insured has no need to pay the premium so that the lender does not need to pay the annual financed premium for the insured borrower in his or her life insurance policy. At the fourteen year of the insurance policy, the contract value may increase to US$8,849,329 that has been already more than the total premium loan US$7,938,738, including the premium loan balance plus the premium loan interest, and can be paid off from the contract value. Therefore, based on for example a credit rate of merely 7.12%, the loan agreement and security agreement between the lender and the insured borrower completed and terminated and the life insurance policy will solely owned by the insured.

In addition, the insured can borrow, for example, an amount US$259,794 each year from the contract value of the life insurance policy until a death of the insured, for example at the age of ninety years old. The beneficiary of this life insurance may still receive a net death benefit of US$6,762,547. In addition to the 19 years of borrowed loan from contract value by the insured, that is US$4,936,086, a total of US$11,698,633 will be benefited by the insured from his or her life insurance policy while the premium was actually paid by the premium loan from the lender.

To ensure the effective of the premium loan from the lender so as to remain the life insurance policy in force and avoid any default of the life insurance policy by the lender, the insured borrower is encouraged to simply pay the interest of the premium loan for the financed premium annually. In other words, the insured borrow has no need to pay the annual premium but merely the interest of the premium loan thereof.

In addition to the lender of the annual financed premium, a third party is introduced by the insurance carrier to provide a letter of credit as an additional collateral to the payment of the interest of the premium loan, especially when the insured borrower select not to pay the annual interest of the premium loan by himself or herself. Therefore, even though the earning income from the contract value of the year does not cover the interest of the premium loan, the third party will pay the interest of the premium loan as a third party loan. The letter of credit can be secured by the assets of the insured borrower. The insured borrow and the third party can be engaged with another security agreement incorporated with the life insurance policy and the security agreement between the lender, the insured borrower and the insurance carrier. According to the exemplary embodiment of the present invention as shown in FIG. 1, the letter of credit may simply cover the first eight years of the life insurance policy, covering from the first year to the eighth year for US$314,867, US$460,341, US$608,582, US$634,901, US$612,875, US$539,300, US$322,211, and US$14,487 respectively. Of course, as long as the earning income can cover the interest of the premium loan, the letter of credit will not need to be cashed out. Such letter of credit from the third party can prevent the policy being collapsed.

By means of the premium loan from the lender for the premium as well as the collateral letter of credit, the premiums of the life insurance policy for the insured become collateral financed premiums. It is worth mentioning that a life insurance policy with collateral financed premium according to the present invention is a secure tool for a venture capital to guarantee a return of its investment. The investor may secure its investment in a business in an insurance policy with the collateral financed premium of the present invention, wherein the face amount of the insurance policy can be at least equal to the venture capital investment. Even though the business fails, the investor may still pay back from the loan from the contract value and/or death benefit of the insurance policy of the owner of the business. The business owner or key person of the business may also use the life insurance policy with the collateral financed premium of the present invention for establishing his or her retirement plan as long as this person is qualified by the lender and the insurance carrier.

For example, the venture capital investor can purchase an insurance policy on the invested business for the valuation of the business. If the business is worth for 5 millions, the face amount of the insurance policy is 5 millions. The venture capital investor may select to pay or not pay the interest of the premium loan to the lender. Within 2 to 4 years, the amount invested is in the insurance policy and the lender financed it. If the business owner is dead, the venture capital investor may use the insurance policy to pay off the spouse at a set price and the deceased business owner's estate would pay 50% of the dead benefit to the venture capital investor according to an agreement between the venture capital investor and the business owner.

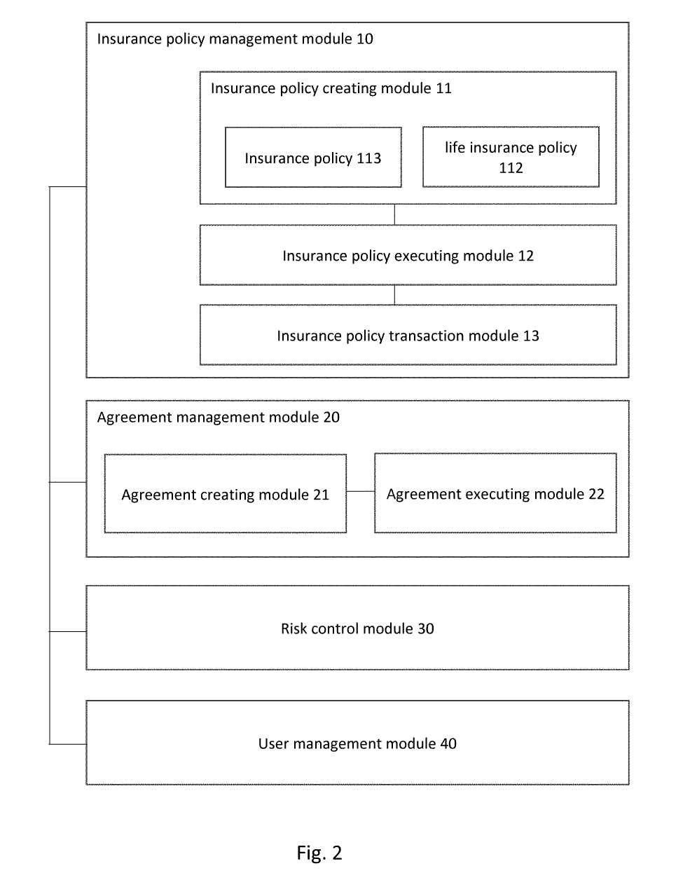

Referring to FIG. 2 of the drawing, a system of structure of the preferred embodiment of the present invention is illustrated. A system of providing collateral financed premium for insurance policy comprises: an insurance policy management module 10, an agreement management module 20 and a user management module 40. The insurance policy management 10, the agreement management module 20 are communicatively connected each other. The user management module 40 is stored the user information, such as the user name, the user account, the user contact information and so on. The user can be an insured, an insurance carrier, a venture capital, a lender or a third party. The user can be an entity or an individual, such as the insured can be an entity or an individual, the insurance carrier can be an entity or an individual. The user is able to purchase an insurance policy through the insurance policy management module 10. It is worth mentioning that the insurance policy provided by the insurance policy management module 10 by paying an insurance carrier such as an insurance company a premium. The user is defined as an insured. The insurance policy management module 10 is able to select the insurance policy provided by the insurance carrier according to the insured information. The insurance policy management module 10 is able to execute the insurance police. More specially, the insurance policy management module 10 is able to pay the premium from the account of the insured to the account of the insurance carrier. It is worth mentioning that the payment of the premium from the account of the insured to the account of the insurance carrier is required the authority of the insured and the insurance carrier.

Preferably, the insurance policy management module 10 is sold a life insurance police. For example, as shown on FIG. 1, an individual purchased a life insurance policy for a face amount US$10,000,000 (death benefit) at the age of fifty seven years old through the insurance policy management module 10. The annual premium will be US$694,079. In other words, after the insurance policy management module 10 is authorized by the insurance carrier and the insured, the insurance policy management module 10 executes the life insurance policy. More specifically, the insurance policy management module 10 pay a premium of US$694,079 every year from the account of the insured to the account of the insurance carrier. The insurance policy management module 10 further monitors the contract value of the insurance policy. If the total contract value accumulated to an amount that is able to gain earning value per year equal to or more than the annual premium to be paid by the insured through the insurance policy management module 10, then the insurance policy management module 10 is able to pay his or her annual premium through using the annual earning income from the contract value by the insurance carrier. The insurance policy management module 10 sends a engaged data to the agreement management module 20. The insurance carrier is authorize by the insured through the insurance policy management module 10. The insured may select to continue to pay the annual premium every year to accumulate the contract value through the insurance policy management module 10. As shown on FIG. 1, the second row shows the title of each column: age 100, annual financed premium 101, beginning loan balance 102, loan rate 103, annual interest 104, ending load balance 105, annual out of pocket 106, contract value 107, surrender value 108, additional collateral required 109, death benefit 110, net death benefit 111.

According to the exemplary embodiment as shown in FIG. 1, the insurance policy management module 10 creates the life insurance policy and configures an annual crediting rate 7.12%. The agreement manager module 20 analyzes the engaged data to determine the insurance policy 113. The agreement management module 20 further analyzes the insurance policy to determine the insured and the insurance carrier. The agreement management module 20 selects a lender, such as a commercial bank, to engage with the insurance carrier and the insured under a security agreement to lend the insured an annual fund equal to the annual premium, for example US$694,079. The agreement management module 20 further secures the loan transaction using this life insurance policy 112 as collateral for the loan for premium payment. The agreement management module 20 defines the annual premium as annual financed premium and the insured as an insured borrower according to above security agreement. The agreement management module 20 creating another loan agreement. Another loan agreement incorporated with the security agreement between the lender and the insured borrower.

The agreement management module 20 is authorized by the lender and the insured borrower. The agreement management module 20 pays the financed premium US$694,079 of the life insurance policy for the insured borrower annually through transferring the payment from the account of the lender to the account of the insurance carrier annually.

The system of providing collateral financed premium for insurance policy further comprises a risk control module 30 for control the risk. In order to ensure the crediting rate of interest can produce earning value to cover the annual premium, the risk control module 30 sends an instruction to the insurance policy management module 10 and the agreement management module 20 for setting the credit rate as zero percent (0%) in a period of the insurance policy when computing the annual interest of the loan for the financed premium with a loan rate of interest. Preferably, the credit rate for the first two years of the insurance is set as zero percent in the security agreement and the insurance policy when computing the annual interest of the loan for the financed premium with a loan rate of interest. A reasonable credit rate, for example 7.12%, will be set starting from the third year of the insurance policy through the insurance policy management module 10. As illustrated in FIG. 1, after the eight years from the insurance policy, at the age of sixty-four, eight financed premiums, a total of US$5,552,632 net loan balance is paid by the lender as eight annual financed premiums for the insured borrower.

The agreement management module 20 configures the premium loan interest change annually. For example it increases by 0.02˜0.03% each year due to the accumulation of the loan balance. For example, the premium loan interests from year one to year fourteen of the insurance policy are 3.89%, 3.92%, 3.94%, 3.99%, 4.02%, 4.04%, 4.07%, 4.09%, 4.12%, 4.14%, 4.17%, 4.19%, and 4.22% respectively. A total of premium loan interest is US$2,386,106. Therefore, the premium loan balance plus the premium loan interest will be a sum of US$7,938,738.

According to the above exemplary embodiment, even though the credit rate is 0% for the first two years and there is no earning income and there is around a 7.12% credit rate from the third, the contract value in the eighth year will be around US$6,019,865 and it can cover the ninth premium. In other words, the insured has no need to pay the premium so that the lender does not need to pay the annual financed premium for the insured borrower in his or her life insurance policy. At the fourteen year of the insurance policy, the contract value may increase to US$8,849,329 that has been already more than the total premium loan US$7,938,738, including the premium loan balance plus the premium loan interest, and can be paid off from the contract value. Therefore, based on for example a credit rate of merely 7.12%, the loan agreement and security agreement between the lender and the insured borrower completed and terminated through the agreement management module 20 and the life insurance policy will solely owned by the insured through the insurance policy management module 20.

Through the insurance policy management module 10, the insured is able to borrow. For example, an amount US$259,794 each year from the contract value of the life insurance policy until a death of the insured, for example at the age of ninety years old. The insurance policy management module 10 computes the beneficiary of this life insurance receiving a net death benefit of US$6,762,547. In addition to the 19 years of borrowed loan from contract value by the insured, that is US$4,936,086, a total of US$11,698,633 will be benefited by the insured from his or her life insurance policy while the premium was actually paid by the premium loan from the lender.

To ensure the effective of the premium loan from the lender so as to remain the life insurance policy in force and avoid any default of the life insurance policy by the lender, the risk control management 30 sends an instruction of paying the interesting of the premium load for the financed premium annually to the agreement management module 20. The agreement management module 20 pays the interesting of the premium load annually from the account of the insured borrower to the lender.

The risk control management 30 sends an letter of credit instruction to the agreement management module 20 to create a credit secure agreement regarding to provide a letter of credit as an addition collateral to the payment of the interest of the premium loan by insured borrower. Especially, when the insured borrower select not to pay the annual interest of the premium loan by himself or herself. The letter of credit is provided by a third party introduced by the insurance carrier. Therefore, even though the earning income from the contract value of the year does not cover the interest of the premium loan, the third party will pay the interest of the premium loan as a third party loan. The risk is controlled through the risk control management 30. The insured borrow and the third party can be engaged with the credit security agreement incorporated with the life insurance policy and the security agreement between the lender, the insured borrower and the insurance carrier. According to the exemplary embodiment of the present invention as shown in FIG. 1, the letter of credit may simply cover the first eight years of the life insurance policy, covering from the first year to the eighth year for US$314,867, US$460,341, US$608,582, US$634,901, US$612,875, US$539,300, US$322,211, and US$14,487 respectively. Of course, as long as the earning income can cover the interest of the premium loan, the letter of credit will not need to be cashed out. Such letter of credit from the third party can prevent the policy being collapsed.

The insurance policy management module 10 further comprises an insurance policy creating module 11 and an insurance executing module 12. The insurance policy creating module 11 creates the insurance policy. The insurance policy creating module 11 receives the instruction sent from the risk control module 30. The insurance policy creates the insurance policy according to the instruction sent from the risk control module 30. The insurance executing module 12 is communicatively connected with the insurance policy creating module 11. The insurance executing module 12 executes the insurance policy. The insurance executing module 12 arranges the insured pay the premium from the account of the insured to the account of the insurance carrier. The insurance policy management module 10 further comprises a insurance transaction module 13 for providing purchase the insurance police. The insurance policy creating module 11 is able to create the life insurance policy.

The agreement management module 20 further comprises an agreement creating module 21 and an agreement executing module 22. The agreement creating module 21 is communicatively connected with the agreement executing module 22. The agreement creating module is able to receive the instruction sent from the risk control module 30 and create the agreement according to the instruction. The agreement creating module 21 is able to create a secure agreement by using the insurance policy as a collateral. The life insurance policy is able to be a collateral for create a secure agreement through the agreement creating module 21. The agreement executing module 22 arranges the payment regarding to the agreement. For example, the agreement executing module 22 arranges the payment regarding to the load agreement. The insured borrower is arranged to pay the payment to the lender through transfer the payment from the account of the insured borrower to the account of the lender.

In another preferred embodiment, the investor purchases a insurance policy for the business invested by the investor through the insurance policy transaction module 13. The face amount of the insurance policy can be at least equal to the venture capital investment. The agreement creating module 21 creating a business secure agreement by using the insurance policy. In other words, the investor secure its investment in a business in an insurance policy with the collateral financed premium of the present invention. Even though the business fails, the investor may still pay back from the loan from the contract value and/or death benefit of the insurance policy of the owner of the business. Furthermore, the business owner or key person of the business purchase life insurance policy through the insurance policy transaction module 13. And then the agreement creating module 21 creates the life secure agreement by using the life insurance policy as a collateral. In other words, The business owner or key person of the business may also use the life insurance policy with the collateral financed premium of the present invention for establishing his or her retirement plan as long as this person is qualified by the lender and the insurance carrier.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of providing collateral financed premium for insurance policy, comprising the steps of:
(A) selecting a life insurance policy, wherein an accumulated contract value of said life insurance policy covers an annual premium of the life insurance police;
(B) providing a loan agreement between a insured of said life insurance police and a lender for using a premium loan to pay said an annual premium of said life insurance policy, wherein said life insurance policy is used as a collateral of said loan agreement; and
(C) terminating said life insurance policy and said loan agreement while said accumulated contract value of said life insurance policy covers said premium load and said premium interest of said loan agreement.

2. The method of providing collateral financed premium for insurance policy, as recited in claim 1, further comprises a step of I between the step (B) and step (C):
(I) borrowing from said lender according to the a net death benefit of said life insurance policy and accumulated borrow load from contract value while said premium loan paid from said lender.

3. The method of providing collateral financed premium for insurance policy, as recited in claim 1, further comprises a step:
(II) avoiding a default of said life insurance policy by said lender through paying an interest of said premium loan by said insured.

4. The method of providing collateral financed premium for insurance policy, as recited in claim 1, further comprises a step:
(III) paying the interest of said premium load through an additional collateral provided by said third party.

5. The method of providing collateral financed premium for insurance policy, as recited in claim 4, wherein said additional collateral is a letter of credit.

6. The method of providing collateral financed premium for insurance policy, as recited in claim 5, wherein said third party is introduced by an insurance carrier of said life insurance policy.

7. The method of providing collateral financed premium for insurance policy, as recited in claim 5, wherein said letter of credit covers a period of interest of said premium load.

8. The method of providing collateral financed premium for insurance policy, as recited in claim 5, wherein an earning income covers said interest of said premium loan, said letter of credit stopping being cashed out.

9. The method of providing collateral financed premium for insurance policy as recited in claim 1, wherein a collateral assignment is recorded on a books of an insurance carrier that issued said life insurance policy.

10. The method of providing collateral financed premium for insurance policy as recited in claim 1, wherein a credit rate for first two years of said insurance policy is set as zero percent in said loan agreement and said insurance policy.

11. The method of providing collateral financed premium for insurance policy, as recited in claim 10, wherein said credit rate is set starting 7.12% from the third year of said life insurance policy.

12. The method of providing collateral financed premium for insurance policy, as recited in claim 10, wherein said premium loan interest is change annually.

13. A method of providing collateral financed premium for insurance policy, comprises the steps of:
(I) purchasing an insurance policy with collateral financed premium on a invested business for a valuation of said invested business by a venture capital investor;
(II) purchasing a life insurance policy with collateral financed premium on a business owner of said invested business; and
(III) setting a agreement between said venture capital investor and said business owner of said invested business regarding to pay off the spouse of the business owner through said insurance policy and pay off said venture capital investor through said life insurance policy of said business owner.

14. The method of providing collateral financed premium for insurance policy, as recited in claim 13, comprises a step of:
(IV) purchasing a life insurance policy on a key person of said invested business.

15. The method of providing collateral financed premium for insurance policy, comprising a step of:
(V) setting an agreement between said venture capital investor and said key person of said invested business regarding to pay off the spouse of the business owner through said insurance policy and pay said venture capital investor through said life insurance policy of said business owner.

16. The method of providing collateral financed premium for insurance policy as recited in claim 13, wherein said insurance policy with collateral financed premium defines:
(I.1) paying an annual premium of said insurance policy until a contract value of said insurance policy covered said annual premium of said insurance policy by said venture capital investor;
(1.2) securing a load agreement between said venture capital investor and a lender through using said insurance policy as a collateral; and
(1.3) paying said an annual premium of said insurance policy through a load premium of said load agreement by said lender while said contract value of said insurance policy covered said annual premium of said insurance policy.

17. The method of providing collateral financed premium for insurance policy as recited in claim 13, wherein said life insurance policy with collateral financed premium defines:
(I.1) paying an annual premium of said life insurance policy until a contract value of said insurance policy covered said annual premium of said insurance policy by said business owner;
(I.2) securing a load agreement between said business owner and a lender through using said life insurance policy as a collateral; and
(I.3) paying said an annual premium of said life insurance policy through a load premium of said load agreement by said lender while said contract value of said insurance policy covered said annual premium of said insurance policy.

18. The method of providing collateral financed premium for insurance policy, as recited in claim 16, further comprises a step:
(a) avoiding a default of said life insurance policy by said lender through paying an interest of said premium loan by said insured.

19. The method of providing collateral financed premium for insurance policy, as recited in claim 16, further comprises a step:
(b) paying the interest of said premium load through an additional collateral provided by said third party.

20. The method of providing collateral financed premium for insurance policy, as recited in claim 18, wherein said additional collateral is a letter of credit.
